(19) United States
(12) Patent Application Publication
(10) Pub. No.: US 2022/0371194 A1
(43) Pub. Date: Nov. 24, 2022

(54) METHOD FOR CONTROLLING A ROBOTIC DEVICE

(71) Applicant: Robert Bosch GmbH, Stuttgart (DE)

(72) Inventors: Niels Van Duijkeren, Kornwestheim (DE); Andras Gabor Kupcsik, Boeblingen (DE); Leonel Rozo, Boeblingen (DE); Mathias Buerger, Stuttgart (DE); Meng Guo, Renningen (DE); Robert Krug, Neu-Ulm (DE)

(21) Appl. No.: 17/661,045

(22) Filed: Apr. 27, 2022

(30) Foreign Application Priority Data
May 10, 2021 (DE) 10 2021 204 697.5

(51) Int. Cl. B25J 9/16

(52) U.S. Cl. CPC B25J 9/1664; B25J 9/163; B25J 9/1653; B25J 9/1607

(57) ABSTRACT

A method for controlling a robotic device. The method includes providing demonstrations for carrying out a skill by the robot, each demonstration including a robot pose, an acting force as well as an object pose for each point in time of a sequence of points in time, ascertaining an attractor demonstration for each demonstration, training a task-parameterized robot trajectory model for the skill based on the attractor trajectories and controlling the robotic device according to the task-parameterized robot trajectory model.

### CROSS REFERENCE

The present application claims the benefit under 35 U.S.C. § 119 of German Patent Application No. DE 10 2021 204 697.5 filed on May 10, 2021, which is expressly incorporated herein by reference in its entirety.

### FIELD

The present invention relates to a method for controlling a robotic device.

### BACKGROUND INFORMATION

The implementation of a skill with force transfer is an important functionality for the implementation of tasks by robots in industry. While a rigid kinematic path tracking is often sufficient for simple pick-up and placing tasks, it is insufficient for tasks that require an explicit interaction with the surroundings. When assembling, for example, an engine, a metal shaft, for example, must (as a first skill) be pressed firmly into a hole. In contrast thereto, a sleeve must (as a second skill) be pushed gently over the metal shaft, it being necessary to rotate it so that the inner structures of the sleeve follows the outer structures of the metal shaft and damages are avoided. These two skills require uniquely different kinematic trajectories, force trajectories and stiffness values.

Accordingly, approaches are desirable for controlling a robot to carry out skills, which have different requirements with respect to the forces exerted by the robot (i.e., the resilience of the robot when it meets resistance during execution of the skill).

### SUMMARY

According to various specific example embodiments of the present invention, a method for controlling a robotic device is provided, including providing demonstrations for carrying out a skill by the robot, each demonstration including for each point in time of a sequence of points in time a pose of one component of the robotic device, a force acting on the component of the robotic device as well as a pose of the object manipulated by the skill, ascertaining, for each demonstration, an attractor demonstration by ascertaining a training attractor trajectory by calculating, for each point in time of the sequence of points in time, an attractor pose via a linear combination of the pose for that point in time, the speed of the component of the robotic device at that point in time, the acceleration of the component of the robotic device at that point in time and the force acting on the component of the robotic device at that point in time, the speed being weighted with a damping matrix and an inverse stiffness matrix and the acceleration and the force being weighted with the inverse stiffness matrix, and supplementing an attractor demonstration with the attractor trajectory using the poses of the object manipulated by the skill for each point in time of the sequence of points in time, training a task-parameterized robot trajectory model for the skill based on the attractor trajectories and controlling the robotic device according to the task-parameterized robot trajectory model.

The above-described method for controlling a robot makes it possible for a robot to carry out for various scenarios (even those, that have not been explicitly shown in demonstrations) a skill with the desirable force transfer (i.e., with a desirable degree of resilience or stiffness, i.e., with a desirable force with which the robot responds to resistance).

Various exemplary embodiments of the present invention are specified below.

Exemplary embodiment 1 is a method for controlling a robot as described above.

Exemplary embodiment 2 is a method according to exemplary embodiment 1, where the robot trajectory model is task-parameterized by the object pose.

This enables a control even in scenarios with object poses, which did not occur in any of the demonstrations.

Exemplary embodiment 3 is a method according to exemplary embodiment 1 or 2, the robot trajectory model being a task-parameterized Gaussian mixed model.

A task-parameterized Gaussian mixed model enables an efficient training based on demonstrations and is applied in this case to the attractor demonstrations.

Exemplary embodiment 4 is a method according to exemplary embodiment 3, the controlling including: ascertaining a first sequence of Gaussian components for maximizing the probability that the Gaussian components provide a given initial configuration and/or a desirable end configuration, controlling the robotic device according to the first sequence of Gaussian components, observing configurations occurring during the control and, at at least one point in time in the course of controlling, adapting the sequence of Gaussian components to a second sequence of Gaussian components for maximizing the probability that the Gaussian components provide the given initial configuration and/or the desirable end configuration and the observed configurations, and controlling the robotic device according to the second sequence of Gaussian components.

Thus, during controlling (“online”) the achieved or occurring configurations are observed (in particular, object poses) and the control sequence is adapted accordingly. Control errors or external interferences, in particular, may be compensated for.

Exemplary embodiment 5 is a method according to exemplary embodiment 4, a switch being made in a transition phase from the controlling according to the first sequence to a controlling according to the second sequence, controlling taking place in the transition phase according to an inserted Gaussian component with a duration, which is proportional to the difference between the pose of the robotic device at the start of the switch and of the mean value of the Gaussian component of the second sequence, with which controlling is continued after the switch to the controlling according to the second sequence.

The transition phase ensures that no excessively abrupt switching in the control occurs, which could result in dangerous or damaging behavior, rather a switch is made smoothly from the one control sequence to the other control sequence.

Exemplary embodiment 6 is a robot control unit, which is configured to carry out the method according to one of exemplary embodiments 1 through 5.

Exemplary embodiment 7 is a computer program including commands which, when they are executed by a processor, prompt the processor to carry out a method according to one of exemplary embodiments 1 through 5.

Exemplary embodiment 8 is a computer-readable medium, which stores commands which, when they are executed by a processor, prompt the processor to carry out a method according to one of exemplary embodiments 1 through 5.

### BRIEF DESCRIPTION OF THE DRAWINGS

In the figures, similar reference numerals refer in general to the same parts in all the various views. The figures are not necessarily true to scale, the emphasis instead being placed in general on the representation of the principles of the present invention. In the following description, various aspects of the present invention are described with reference to the figures.

FIG. 1 shows a robot in accordance with an example embodiment of the present invention.

FIG. 2 shows a flowchart, which represents a method for controlling a robot according to one specific embodiment of the present invention.

FIG. 3 illustrates an online adaptation in a change of the object pose, in accordance with an example embodiment of the present invention.

FIG. 4 shows a flowchart of a method for controlling a robotic device according to one specific example embodiment of the present invention.

### DETAILED DESCRIPTION OF EXAMPLE EMBODIMENTS

The following detailed description refers to the figures which, for the purpose of explanation, show specific details and aspects of this description, in which the present invention may be carried out. Other aspects may be used and structural, logical and electrical changes may be carried out without departing from the scope of protection of the present invention. The various aspects of this description are not necessarily mutually exclusive, since some aspects of this description may be combined with one or with multiple other aspects of this description in order to form new aspects.

Various examples of the present invention are described in greater detail below.

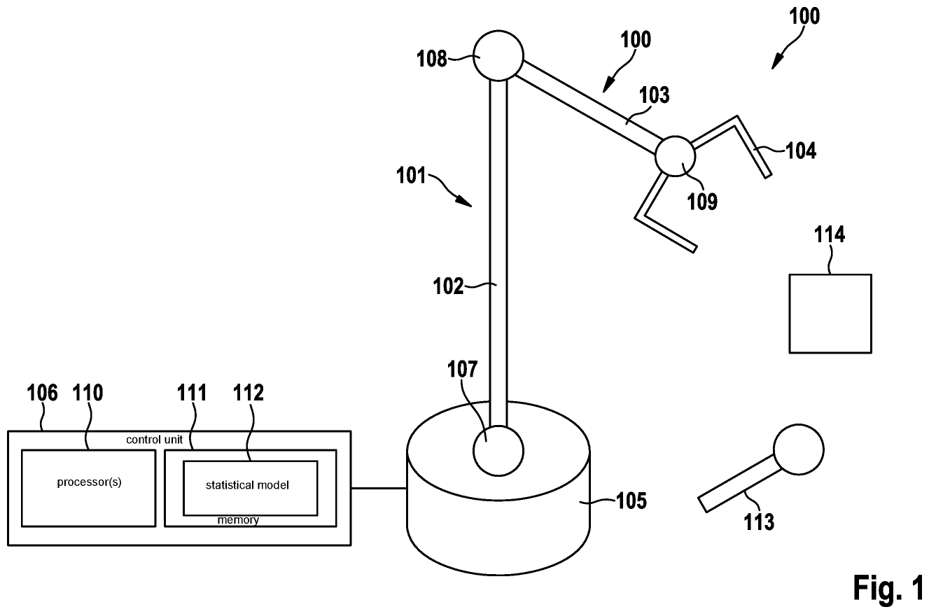

FIG. 1 shows a robot 100.

Robot 100 includes a robotic arm 101, for example, an industrial robotic arm for manipulating or mounting a workpiece (or one or multiple other objects). Robotic arm 101 includes manipulators 102, 103, 104 and a base (or support) 105, with the aid of which manipulators 102, 103, 104 are supported. The term “manipulator” refers to the movable elements of robotic arm 101, the actuation of which enables a physical interaction with the surroundings, for example, in order to carry out a task. For the control, robot 100 includes a (robot) control unit 106, which is configured for the purpose of implementing the interaction with the surroundings according to a control program. Last element 104 (which is furthest away from base 105) of manipulators 102, 103, 104 is also referred to as end effector 104 and may include one or multiple tools such as, for example, a welding torch, a gripping instrument, a painting device, or the like.

Other manipulators 102, 103 (closer to base 105) may form a positioning device so that, together with end effector 104, robotic arm 101 is provided with end effector 104 at its end. Robotic arm 101 is a mechanical arm, which is able to fulfill functions similar to a human arm (possibly with a tool at its end).

Robotic arm 101 may include joint elements 107, 108, 109, which connect manipulators 102, 103, 104 to one another and to base 105. A joint element 107, 108, 109 may include one or multiple joints, each of which is able to provide a rotational movement and/or a translational movement (i.e., displacement) of associated manipulators relative to one another. The movement of manipulators 102, 103, 104 may be initiated with the aid of actuators, which are controlled by control unit 106.

The term “actuator” may be understood to mean a component, which is designed to influence a mechanism or process in response to its drive. The actuator is able to implement commands, which are output by control unit 106 (the so-called activation) into mechanical movements. The actuator, for example, an electromechanical converter, may be designed to convert electrical energy into mechanical energy in response to its activation.

The term “control unit” may be understood to mean any type of logic that implements an entity, which may include, for example, a circuit and/or a processor, which is/are able to execute a software, which is stored in a memory medium, firmware or a combination thereof, and is able, for example, to output the commands, for example, to an actuator in the present example. The control unit may, for example, be configured by a program code (for example, software) in order to control the operation of a robot.

In the present example, control unit 106 includes one or multiple processors 110 and one memory 111, which stores code and data, on the basis of which processor 110 controls robotic arm 101. According to various specific embodiments, control unit 106 controls robotic arm 101 on the basis of a statistical model 112, which is stored in memory 111.

Robot 100 is intended, for example, to pick up a first object 113 and to attach it to a second object 114. For example, end effector 104 is a gripper and is intended to pick up first object 113, however, end effector 104 may also be configured, for example, to use suction to pick up object 113.

Robot 100 is intended, for example, to attach first object 113 to second object 114 in order to assemble a device. Various requirements may occur during the process as to how resilient (or to the contrary, how stiffly) the robot proceeds in the process.

For example, when assembling an engine, a metal shaft must be pressed firmly (stiffly) into a hole and then a sleeve must be pushed (gently, i.e., resiliently) over the metal shaft in order to take into account (and not to damage) inner structures of the sleeve and matching outer structures of the metal shaft.

The robot is thus intended to be able to execute a skill with different stiffness or resilience.

For this purpose, the statistical model may be trained by learning from demonstrations (LfD).

In this case, it is possible to code human demonstrations using statistical mode 112 (also referred to as a probabilistic model), which represents the nominal plan of the task for the robot. Control unit 106 may subsequently use statistical model 112, which is also referred to as a robot trajectory model, in order to generate desirable robot movements.

The basic idea of LfD is to adapt a prescribed movement skill model such as, for example, GMMs (Gaussian mixed models) to a set of demonstrations. M demonstrations are to be available, each Tₘ of which contains data points for a data set of N=ΣₘTₘ total observations ξ={ξₜ}ₜ₌₁^{N}, where ξₜ∈ [symbol] ^{d}. It is also assumed that the same demonstrations are recorded from the perspective of P different coordinate systems (provided by the task parameters such as, for example, local coordinate systems or reference frameworks of objects of interest). A customary way of obtaining such data is to transform the demonstrations from a static, global reference framework into a (local) reference framework p via ξₜ^{(p)}=A^{(p)}^{^{−1}}(ξₜ−b^{(p)}). Here, {(b^{(p)},A^{(p)})}ₚ₌₁^{P} is the translation and rotation of (local) reference framework p in relation to a global coordinate system (i.e., to the global reference framework). A TP-GMM (task-parameterized GMM) is then described by model parameters {πₖ,{μₖ^{(p)},Σₖ^{(p)}}ₚ₌₁^{P}}ₖ₌₁^{K}, K representing the number of Gaussian components in the mixed model, πₖ being the previous probability of each component and {μₖ^{(p)},Σₖ^{(p)}}ₚ₌₁^{P} being the parameters of the k-th Gaussian component within reference framework p.

In contrast to the standard GMM, the above mixed model is not able to be learned independently for each reference framework. In fact, mixed coefficients πₖ are shared by all reference frameworks and the k-th component in reference framework p must be mapped onto the corresponding k-th component in the global reference framework. Expected maximization (EM) is an established method in order to learn such models.

Once it is learned, the TP-GMM may be used during the execution in order to reproduce a trajectory for the learned movement skill. This includes the control of the robot so that from an initial configuration, it reaches a target configuration (for example, its end effector 104 moves from an initial pose to an end pose). For this purpose, the (time-dependent) acceleration at the joint elements 107, 108, 109 is calculated. In view of observed reference frameworks {b^{(p)},A^{(p)}}ₚ₌₁^{P}, the learned TP-GMM is converted into a single GMM with parameters {πₖ,(\hat{μ}ₖ,\hat{Σ}ₖ)}ₖ₌₁^{K} by multiplying the affinely transformed Gaussian components across various reference frameworks, as follows

$${\hat{\sum }}_{k} = {[ {\sum }_{p = 1}^{P} {( {\hat{\sum }}_{k}^{( p )} )}^{- 1} ]}^{- 1} , {\hat{μ}}_{k} = {\hat{\sum }}_{k} [ {\sum }_{p = 1}^{P} {( {\hat{\sum }}_{k}^{( p )} )}^{- 1} {\hat{μ}}_{k}^{( p )} ] , \qquad ( 1 )$$

the parameters of the updated Gaussian bell curve at each reference framework p being calculated as \hat{μ}ₖ^{(p)}=A^{(p)}μₖ^{(p)}+b^{(p)}, \hat{Σ}ₖ^{(p)}=A^{(p)}Σₖ^{(p)}A^{(p)}^{^{T}}. Although, the task parameters may vary over time, the time index is omitted due to the notation.

Hidden semi-Markov models (HSMM) expand hidden standard Markov models (HMMs) by embedding pieces of time information of the underlying stochastic process. This means, whereas in HMM the underlying hidden process is assumed to be Markov, i.e., the probability of the transition to the next state is a function only of the instantaneous state, in HSMM, the state process is assumed to be semi-Markov. This means that a transition to the next state is a function of the instantaneous state as well as of the time passed since the state has been entered into. They may be applied in combination with TP-GMMs for robot movement skill coding, in order to learn spatial-temporal features of the demonstrations. A task-parameterized HSMM model (TP-HSMM model) is defined as:

Θ={{aₕₖ}ₕ₌₁^{K},(μₖ^{D},σₖ^{D}),πₖ,{(μₖ^{(p)},Σₖ^{(p)})}ₚ₌₁^{P}}ₖ₌₁^{K}, (2)

aₕₖ being the transition probability of state h to k; (μₖ^{D},σₖ^{D}) describing the Gaussian distributions for the duration of state k, i.e., the probability that state k is maintained for a particular number of consecutive steps; {πₖ,{μₖ^{(p)},Σₖ^{(p)}}ₚ₌₁^{P}}ₖ₌₁^{K} being equal to the earlier introduced TP-GMM, which represents the observation probability that corresponds to state k. It should be noted here that the number of states represents the number of Gaussian components in the “connected” TP-GMM.

In view of a particular (partial) sequence of observed data points [symbol] , it is to be assumed that the associated sequence of states in Θ is provided by sₜ=s₁ s₂ . . . sₜ. The probability that data point ξₜ belongs to state k (i.e., sₜ=k), is provided by forward variable αₜ(k)=p(sₜ=k,{ξₗ}ₗ₌₁^{t}):

αₜ(k)=Σ_{τ=1}^{t-1}Σ_{t-τ}(h)aₕₖ [symbol] (τ|μₖ^{D},σₖ^{D})o_{τ}^{t}, (3)

o_{τ}^{t}= [symbol] ( [symbol] |\hat{μ}ₖ,\hat{Σ}ₖ) being the emission probability and (\hat{μ}ₖ,\hat{Σ}ₖ) being derived from (1) in view of the task parameters. Furthermore, the same forward variable may also be used during the reproduction in order to predict future steps up to Tₘ.

Since, in this case, however, future observations are not available, only pieces of transition information and duration information are used, i.e., by setting [symbol] |\hat{μ}ₖ,\hat{Σ}ₖ)=1 for all k and [symbol] >t in (2). Finally, the sequence of the most probable states s_{T}_{ₘ}*=s₁*s₂* . . . s_{T}_{ₘ}* is determined by selecting sₜ*=argmaxₖ αₜ(k), ∀1≤t≤Tₘ.

Now a desired end observation of robot state is to be provided as ξ_{T}, T being the movement skill time horizon (for example, the average length across the demonstrations). Moreover, the initial robot state is observed as ξ₁. For the execution of the movement skill (i.e., movement skill reproduction) in view of learned model Θₐ, only the most probable state sequence s_{T}* is constructed in view of only ξ₁ and ξ_{T}.

The reproduction using the forward variable is unable to directly take place in this case, since the forward variable in equation (3) calculates the sequence of marginally most probable states, whereas that which is desired, is the collectively most probable sequence of states in view of ξ₁ and ξ_{T}. As a result, if (3) is used, no guarantee exists that the returned sequence s_{T}* corresponds both to the spatial-temporal patterns of the demonstration as well as to the end observation. With respect to one example for picking up an object, it may return a most probable sequence, which corresponds to “picking up from the side,” even if the desirable end configuration is that the end effector is situated at the upper side of the object.

According to one specific embodiment, a modification of the Viterbi algorithm is used. The classical Viterbi algorithm may be used in order to find the most probable sequence of states (also called Viterbi path) in HMMs, which result in a given sequence of observed events. According to one specific embodiment, a method is used, which differs from the latter in two main aspects: (a) it operates with an HSMM instead of an HMM; and more significantly, (b) most of the observations aside from the first and the last are lacking. In the absence of observations, in particular, the Viterbi algorithm becomes

$${δ}_{t} ( j ) = {max}_{d ∈ 𝒟} {max}_{i \neq j} {δ}_{t - d} ( i ) {a}_{ij} {p}_{j} ( d ) {\prod }_{{t}^{′} = t - d + 1}^{t} {\tilde{b}}_{j} ( {ξ}_{{t}^{′}} ) , \\ {δ}_{1} ( j ) = {b}_{j} ( {ξ}_{1} ) {π}_{j} {p}_{j} ( 1 ) , \qquad ( 4 )$$

pⱼ(d)= [symbol] (d|μⱼ^{D},σⱼ^{D}) being the duration probability of state j, δₜ(j) being the probability that the system is in state j at time t and not in state j at t+1; and

$${\tilde{b}}_{j} ( {ξ}_{{t}^{′}} ) = \{ \begin{matrix}𝒩 ( {ξ}_{{t}^{′}} \vert {\hat{μ}}_{j} , {\hat{\sum }}_{j} ) , & t = 1 ⋁ t = T ; \\ 1 , & 1 < t < T .\end{matrix}$$

(\hat{μ}ⱼ,\hat{Σ}ⱼ) global Gaussian component j in Θₐ provided by (1) being ξₜ. At any time t and for each state j, the two arguments that maximize equation δₜ(j) are namely recorded and a simple backtracking procedure is used in order to find the most probable state sequence s_{T}*. In other words, the above algorithm derives most probable sequence s_{T}* for movement skill a, resulting in end observation ξ_{T}, starting from ξ₁.

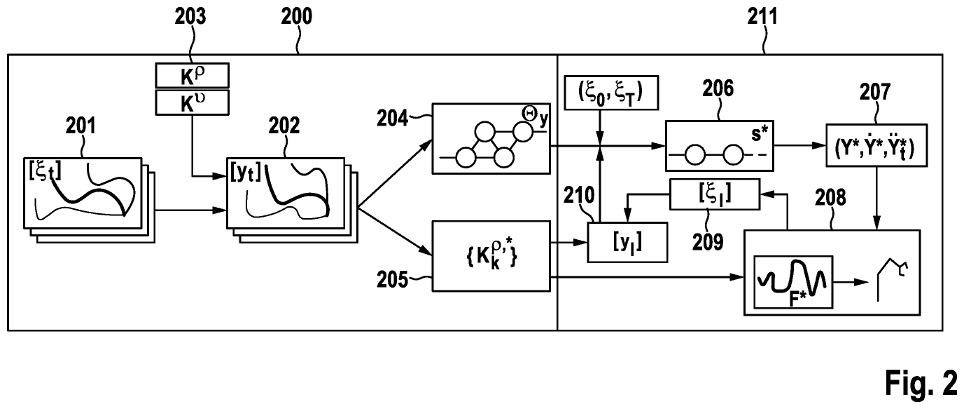

In order to take into account the above requirements, that the robot should be able to execute a skill with different stiffness or resilience, according to various specific embodiments, the above approach for learning from demonstrations is not directly applied to demonstrations ξ={ξₜ}ₜ₌₁^{N}, but to so-called attractor demonstrations y={yₜ}ₜ₌₁^{N}, which are ascertained from the demonstrations. This is explained in greater detail below. FIG. 2 shows a flowchart, which represents a method for controlling a robot according to one specific embodiment.

For the following explanations, a robotic arm 101 having multiple degrees of freedom is considered as an example, whose end effector 104 exhibits a state x∈ [symbol] ³×S³ (the Cartesian position and the orientation in the robot workspace). For the sake of simplicity, formulas are used below for the Euclidian space.

It is assumed that the control unit implements a Cartesian impedance control according to the Lagrange formula

F=K^{ρ}(x_{d}−x)+K^{ν}(\dot{x}_{d}−\dot{x})+I(q)\ddot{x}_{d}+Ω(q,\dot{q}) (5)

(here, the time index having been omitted for the sake of simplicity). In this case, F is the input torque for the control (projected into the robot workspace), (x_{d},\dot{x}_{d},\ddot{x}_{d}) are the desired pose, speed or acceleration in the workspace, K^{ρ} and K^{ν} are the stiffness matrix and the damping matrix, I(q) is a workspace inertia matrix and Ω(q,\dot{q}) models the internal dynamics of the robot. These last two matrices are a function of angle position q of the joints of the robot and of angle velocity \dot{q} of the angle position of the joints of the robot. These are available during the control.

In 201, demonstrations for a skill including force transfer are carried out (for example, by a human user). This set of demonstrations is referred to as D={D₁, . . . , D_{M}}, each demonstration a (temporally indicated) sequence of observations

Dₘ=[ξₜ]ₜ₌₁^{T}^{ₘ}=[((xₜ,\dot{x}ₜ,\ddot{x}ₜ,fₜ), [symbol] ₜ)]ₜ₌₁^{T}^{ₘ},

at any point in time t, observation ξₜ being made up of robot pose xₜ, speed \dot{x}ₜ, acceleration \ddot{x}ₜ of the external force and of the external torque or external force fₜ and of pose [symbol] ₜ of the manipulated object (for example, of first object 113). Since a torque corresponds to a force with a particular lever arm and accordingly may be converted into one another, force and torque are used equivalently herein.

The demonstrations may be ascertained (for example, recorded) with the aid of a configuration estimation model, an observation module and dedicated sensors (force sensor, camera, etc.).

The aim is to ascertain a movement rule for (impedance) control device 106 operating according to (5), so that robot 100 is able to reproduce the demonstrated skill reliably with the demonstrated pose and force (or torque) profiles, even for new scenarios, i.e., for example, of a new object pose (not occurring in a demonstration).

The sequence shown in FIG. 2 is made up of the training of model 200 (for example, offline, i.e., prior to operation) and of the execution of skill 211 (online, i.e., during operation). The presentation of the demonstrations in 201 is part of the training.

Each demonstration Dₘ=[ξₜ] of demonstrations 201 is converted according to

[symbol]

ₜ=xₜ+Kₜ^{-ρ}(Kₜ^{ν}\dot{x}ₜ+\ddot{x}ₜ−fₜ) (6)

into an associated attractor trajectory [ [symbol] ₜ]. In this case, Kₜ^{-ρ}=(Kₜ^{ρ})⁻¹.

As described, the demonstrated pose, speed, acceleration, and force/torque are converted into one single variable. Accordingly, in the case of great force, the attractor trajectory may deviate drastically from the demonstrated trajectory to which it belongs.

For each demonstration, therefore, an associated attractor demonstration Ψₘ=[( [symbol] ₜ, [symbol] ₜ)] is present. The attractor demonstrations thus generated form a set of attractor demonstrations 202, referred to as Ψ={Ψₘ}. The generation takes place according to equation (6) with the aid of initial values 203 (for example, as standard values of the impedance control unit) for Kₜ^{ρ} and Kₜ^{ν}.

A TP-HSMM 204 is now learned as in equation (2) for the set of attractor demonstrations 202 as described above. This attractor model is identified with [symbol] .

The choice of initial values 203 for Kₜ^{ρ} and Kₜ^{ν} has a large influence on the calculation of the attractor trajectories according to equation (6) and thus on attractor model 204. According to various specific embodiments, these are adapted (optimized).

Instead of determining them at each point in time t, these matrices are optimized locally for each component of [symbol] . If, for example, the k-th component of [symbol] is considered, then the accumulated deviation of the calculated attractor trajectory with respect to this remainder is provided by

$${ε}_{m} = {\sum }_{{ξ}_{t} ∈ {D}_{m}} {p}_{t , k} ( {μ}_{k} - {x}_{t} - {K}_{k}^{- ρ} ( {K}_{t}^{ν} {\dot{x}}_{t} - {\ddot{x}}_{t} - {f}_{t} ) )$$

[symbol]

t, k being the probability that state xₜ belongs to the k-th component, which is a byproduct of the EM algorithm when ascertaining Θ_{y}. In this case, μₖ is the mean value of the k-th component. Kₖ^{-ρ} is the inverse of the stiffness matrix to be optimized, whereas damping matrix Kₜ^{ν} remains unchanged.

An optimized local stiffness matrix for k-th component 205 may be accordingly calculated by minimizing (across all attractor demonstrations) the accumulated deviations according to

$${K}_{k}^{ρ , ★} = {min}_{{K}_{k}^{ρ}} ‖ {\sum }_{{D}_{m}} {ε}_{m} ‖ , s . t . {K}_{k}^{ρ} \geq 0 \qquad ( 7 )$$

which requires that the stiffness matrix is positively semi-definite. The minimization problem (7) may, for example, be solved with the aid of interior point methods.

The above-described approach may also be used on a representation of orientations with the aid of quaternions. This may take place using a formula with the aid of Riemannian manifolds. According to one specific embodiment, the components of attractor model [symbol] are situated in the manifold. A tangential space [symbol] exists for each point x in a manifold [symbol] . The exponential mapping and the logarithm mapping may be used in order to map points between [symbol] and [symbol] . Exponential mapping Expₓ: [symbol] → [symbol] maps a point in the tangent space of point x onto a point on the manifold, whereas the geodetic distance is maintained. The inverse operation is called logarithm mapping Logₓ: [symbol] → [symbol] .

For example, the subtraction of poses in equation (5) may take place with the aid of the logarithm operation and the summation of poses in equation (6) may take place with the aid of the exponential operation. The model components may be calculated iteratively by projection onto the tangential space and back into the manifold. Thus, the use of a formula with the aid of Riemannian manifolds is typically more computationally intensive than the Euclidean formula but ensures the correctness of the results. If the robot workspace is represented by temporally varying locations (including position and orientation) of the end effector, classical Euclidean-based methods are typically unsuitable for processing such data.

Once attractor model 204 and associated stiffness model 205 have been learned in training 200, they may be used for execution 211 of the skill. Execution 211 of the skill is made up of an initial synthesis and an online adaptation.

For the initial synthesis, it is now assumed that robot 100 is to apply the skill that has been demonstrated in a new scenario, in which the poses of the robot and of the object are different from those in the demonstrations. For this new scenario, the P reference frameworks for attractor model 204 are now initially determined in accordance with the new scenario (see the explanations regarding equation (1)).

The global GMM components in the global reference framework are then calculated as a weighted product of the local GMM components (in the object reference frameworks). In addition, the modified Viterbi algorithm (according to (4)) is used for initial observation ξ₀ and (potentially) a desired end observation ξ_{T}, in order to determine the most probable sequence of components 206 of attractor model 204. This sequence 206 is referred to as s*=[sₜ*].

With the aid of linear quadratic tracking (LQT), an optimal and smooth reference trajectory 207 is then ascertained, which follows the sequence of components 206. This reference trajectory 207 is the reference, which robotic arm 101 is intended to follow. It includes a trajectory for the poses and a consistent speed profile and acceleration profile:

Y*=[ [symbol] ],\dot{Y}*=[ [symbol] ],Ÿ*=[ [symbol] ]

If variables sₜ*, [symbol] , [symbol] , [symbol] are now known for each control point in time t, an impedance control 208 according to equation (5) is carried out, stiffness 205 optimized for component sₜ* being used.

Control unit 106 thus controls robotic arm 101 in such a way that it follows desirable attractor trajectory Y* with the desired stiffness.

For the online adaptation (i.e., adaptation during the control), observations 209 such as the instantaneous robot pose or force measurements or torque measurements are carried out while robotic arm 101 moves according to the control. These observations may show deviations or error in the performance of the skill, which may be caused, for example, by external interferences (for example, robot 101 bumps unexpectedly against an obstacle) or by tracking errors. In this way, changes in the scenario such as changed object poses may also be registered. In the following, it is explained how the reference attractor trajectory and the associated stiffness may be adapted in view of such real-time measurements.

A change of an object pose initially causes changes of the task parameters of attractor model [symbol] . Thus, in such a change, the global GMM components may be updated by recalculation of the product of the local GMM components as in the initial synthesis.

The observation probability in (4) and most probable sequence s* change accordingly. Moreover, the set of past observations is no longer empty in (4) as in the initial synthesis. If past observations of the robot pose and force measurements [ [symbol] ]=[( [symbol] )] up to time t are provided, according to equation (6), corresponding (virtual) observations for the attractor trajectory, in particular, are provided, the stiffness matrix and the damping matrix being set to values used in impedance interference [sic; control] 208. These observations 210 from (6) for the attractor trajectory are used for the purpose of ascertaining updated emission probabilities for the entire sequence, i.e.,

$${\tilde{b}}_{k} ( {ξ}_{ℓ} ) = \{ \begin{matrix}𝒩 ( {y}_{ℓ} \vert {\hat{μ}}_{{s}_{ℓ}^{*}} , {\hat{\sum }}_{{s}_{ℓ}^{*}} ) , & ℓ ∈ \{ 1 , 2 , … , t , T \} ; \\ 1 , & ℓ ∈ \{ t + 1 , t + 2 , … , T - 1 \}\end{matrix}$$

$${y}_{ℓ} = {x}_{ℓ} + {K}_{{s}_{ℓ}^{*}}^{- ρ} ( {K}_{ℓ}^{ν} {\dot{x}}_{ℓ} + {\ddot{x}}_{ℓ} - {f}_{ℓ} )$$

being the observations for the attractor trajectory.

The updated emission probabilities are then used again for the modified Viterbi algorithm (according to (4)), in order to ascertain an updated optimal sequence of model components 206.

If an updated sequence of model components is now provided, a transition phase according to one specific embodiment is used in order to switch from a pose observed at point in time t to (according to the updated optimal sequence) newly ascertained associated attractor pose [symbol] ₜ, since these two poses may differ drastically from one another during the course of the control (whereas their difference at the start of the control is typically negligible).

In the transition phase, updated trajectory Y* starts with instantaneous pose xₜ, passes through transition point [symbol] ₜ and then follows the updated optimal sequence of model components 206.

In order to achieve this, an artificial global Gaussian component k_{y} is inserted, whose mean value is [symbol] ₜ, and which has the same covariance as the first component of the updated sequence of model components (from point in time t), stiffness Kₜ^{ρ}′* being used as the instantaneous stiffness. This component is also assigned a duration d_{y}, which is proportional to the distance between xₜ and [symbol] ₜ. Component k_{y} with this duration precedes the updated sequence of model components:

ŝ*=(k_{y} . . . k_{y})s*

The control then further takes place on the basis of ŝ* as the optimal sequence of model components as described above.

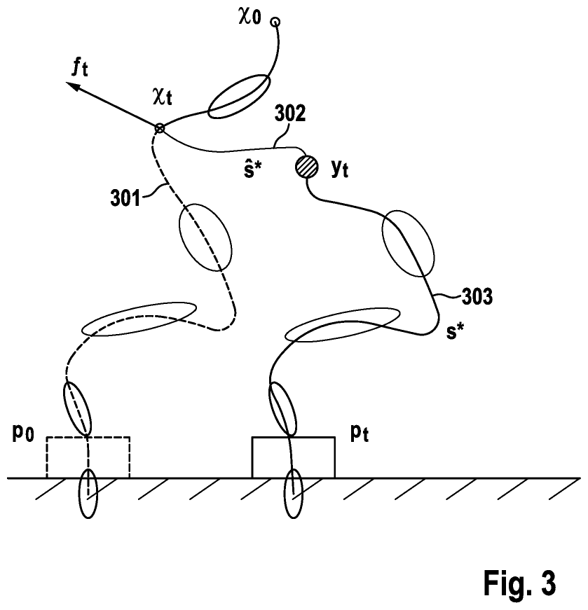

FIG. 3 illustrates an online adaptation in a change of the object pose, to [symbol] ₜ at point in time t, from an observed force fₜ and an observed robot pose xₜ.

Dashed line 301 shows the original trajectory from point in time t (without update), section 302, the trajectory in the transition phase and the line from [symbol] ₜ the updated trajectory, with which the object with changed object pose [symbol] ₜ is reached by robot end effector 104.

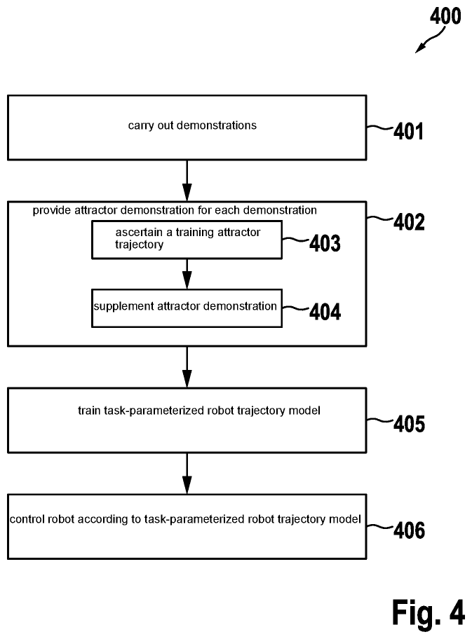

In summary, according to various specific embodiments, a method is provided as represented in FIG. 4.

FIG. 4 shows a flowchart 400, which represents a method for controlling a robotic device according to one specific embodiment.

In 401, demonstrations are provided for carrying out a skill by the robot, each demonstration including for each point in time, a sequence of points in time, a pose of a component of the robotic device, a force acting on the component of the robotic device as well as a pose of the object manipulated by the skill.

In 402, an attractor demonstration is provided for each demonstration by ascertaining a training attractor trajectory in 403 by calculating, for each point in time of the sequence of points in time, an attractor pose via linear combination of the pose for the point in time, the speed of the component of the robotic device at that point in time, the acceleration of the component of the robotic device and the force acting on the component at that point in time, the speed being weighted with a damping matrix and an inverse stiffness matrix, and the acceleration and the force being weighted with the inverse stiffness matrix, and supplementing, in 404, an attractor demonstration with the attractor trajectory using the poses of the object manipulated by the skill for each point in time of the sequence of points in time.

In 405, a task-parameterized robot trajectory model for the skill is trained based on the attractor trajectories.

In 406, the robot is controlled according to the task-parameterized robot trajectory model.

In other words, according to various specific embodiments, demonstrations are provided (for example, recorded), each of which, in addition to a trajectory (i.e., a time series that includes a pose and, if necessary, speed and acceleration) also includes pieces of force (or torque) information about the force (or torque) acting at the various points in time of the time series on the robotic device (e.g. on an object held by a robot arm). These demonstrations are then converted into attractor demonstrations, which include attractor trajectories, into which the pieces of force information are coded. For these demonstrations, a robot trajectory model may then be learned in the usual manner and the robotic device may be controlled using the learned robot trajectory model.

The method of FIG. 4 may be carried out by one or by multiple computers including one or with multiple data processing units. The term “data processing unit” may be understood to be any type of entity that enables the processing of data or of signals. The data or signals may be handled, for example, according to at least one (i.e., one or more than one) specific function, which is carried out by the data processing unit. A data processing unit may include or be designed from an analog circuit, a digital circuit, a logic circuit, a microprocessor, a microcontroller, a central unit (CPU), a graph processing unit (GPU), a digital signal processor (DSP), an integrated circuit of a programmable gate array (FPGA) or any combination thereof. Any other manner for implementing the respective functions, which are described in greater detail herein, may also be understood as a data processing unit or logic circuit array. One or multiple of the method steps described in detail herein may be carried out (for example, implemented) by a data processing unit via one or multiple specific functions, which are carried out by the data processing unit.

The approach of FIG. 4 is used to generate a control signal for a robotic device. The term “robotic device” may be understood as referring to any physical system (including a mechanical part, whose movement is controlled), such as, for example, a computer-controlled machine, a vehicle, a household appliance, a power tool, a manufacturing machine, a personal assistant or an access control system. A control rule for the physical system is used and the physical system is then controlled accordingly.

Various specific embodiments may receive and use sensor signals from various sensors such as, for example, video, radar, LIDAR, ultrasound, movement, heat mapping, etc., for example, in order to obtain sensor data with respect to demonstrations or states of the system (robot and object or objects) and configurations and scenarios. The sensor data may be processed. This may include the classification of the sensor data or the implementation of a semantic segmentation on the sensor data, for example, in order to detect the presence of objects (in the surroundings, in which the sensor data have been obtained). Specific embodiments may be used for training a machine learning system and for controlling a robot, for example, autonomously by robotic manipulators, in order to achieve various manipulation tasks using various scenarios. Specific embodiments are applicable, in particular, to the control and monitoring of the execution of manipulation tasks, for example, in assembly lines. They may be integrated, for example, seamlessly with a conventional GUI for a control process.

Although specific embodiments have been represented and described herein, those skilled in the art will recognize that the specific embodiments shown and described may be replaced by a variety of alternative and/or equivalent implementations without departing from the scope of protection of the present invention. This application is intended to cover any adaptations or variations of the specific embodiments discussed herein. Thus, the present invention is intended to be limited only by the claims and by the equivalents thereof.

What is claimed is:

1. A method for controlling a robotic device, comprising the following steps:
providing demonstrations for carrying out a skill by the robot, each demonstration of the demonstrations including, for each point in time of a sequence of points in time, a pose of one component of the robotic device, a force acting on the component of the robotic device, and a pose of the object manipulated by the skill;
ascertaining, for each demonstration of the demonstrations, an attractor demonstration by:
ascertaining a training attractor trajectory by calculating, for each point in time of the sequence of points in time, an attractor pose using a linear combination of the pose for the point in time, a speed of the component of the robotic device at the point in time, an acceleration of the component of the robotic device and a force acting on the component of the robotic device at the point in time, the speed being weighted with a damping matrix and an inverse stiffness matrix and the acceleration and the force being weighted with the inverse stiffness matrix, and
supplementing the attractor demonstration with the attractor trajectory using the poses of the object manipulated by the skill for each point in time of the sequence of points in time;
training a task-parameterized robot trajectory model for the skill based on the attractor trajectories; and
controlling the robotic device according to the task-parameterized robot trajectory model.

2. The method as recited in claim 1, wherein the robot trajectory model is task-parameterized by the object pose.

3. The method as recited in claim 1, wherein the robot trajectory model is a task-parameterized Gaussian mixed model.

4. The method as recited in claim 3, wherein the controlling includes:
ascertaining a first sequence of Gaussian components for maximizing a probability that the Gaussian components provide a given initial configuration and/or a desirable end configuration;
controlling the robotic device according to the first sequence of Gaussian components;
observing configurations occurring during the controlling and, at at least one point in time in the course of the controlling, adapting the sequence of Gaussian components to a second sequence of Gaussian components for maximizing the probability that the Gaussian components provide the given initial configuration and/or the desirable end configuration and the observed configurations; and
controlling the robotic device according to the second sequence of Gaussian components.

5. The method as recited in claim 4, wherein a switch is made in a transition phase from the controlling according to the first sequence to the controlling according to the second sequence, controlling taking place in the transition phase according to an inserted Gaussian component with a duration, which is proportional to a difference between the pose of the robotic device at a start of the switch and of a mean value of the Gaussian component of the second sequence, with which controlling is continued after the switch to the controlling according to the second sequence.

6. A robot control unit configured to control a robotic device, the control unit configured to:
provide demonstrations for carrying out a skill by the robot, each demonstration of the demonstrations including, for each point in time of a sequence of points in time, a pose of one component of the robotic device, a force acting on the component of the robotic device, and a pose of the object manipulated by the skill;
ascertain, for each demonstration of the demonstrations, an attractor demonstration by:
ascertaining a training attractor trajectory by calculating, for each point in time of the sequence of points in time, an attractor pose using a linear combination of the pose for the point in time, a speed of the component of the robotic device at the point in time, an acceleration of the component of the robotic device and a force acting on the component of the robotic device at the point in time, the speed being weighted with a damping matrix and an inverse stiffness matrix and the acceleration and the force being weighted with the inverse stiffness matrix, and
supplementing the attractor demonstration with the attractor trajectory using the poses of the object manipulated by the skill for each point in time of the sequence of points in time;
train a task-parameterized robot trajectory model for the skill based on the attractor trajectories; and
control the robotic device according to the task-parameterized robot trajectory model.

7. A non-transitory computer-readable medium on which is stored a computer program including commands for controlling a robotic device, the commands, when executed by a processor, causing the processor to perform the following steps:
providing demonstrations for carrying out a skill by the robot, each demonstration of the demonstrations including, for each point in time of a sequence of points in time, a pose of one component of the robotic device, a force acting on the component of the robotic device, and a pose of the object manipulated by the skill;
ascertaining, for each demonstration of the demonstrations, an attractor demonstration by:
ascertaining a training attractor trajectory by calculating, for each point in time of the sequence of points in time, an attractor pose using a linear combination of the pose for the point in time, a speed of the component of the robotic device at the point in time, an acceleration of the component of the robotic device and a force acting on the component of the robotic device at the point in time, the speed being weighted with a damping matrix and an inverse stiffness matrix and the acceleration and the force being weighted with the inverse stiffness matrix, and
supplementing the attractor demonstration with the attractor trajectory using the poses of the object manipulated by the skill for each point in time of the sequence of points in time;
training a task-parameterized robot trajectory model for the skill based on the attractor trajectories; and
controlling the robotic device according to the task-parameterized robot trajectory model.
